(19) United States
(12) Patent Application Publication
(10) Pub. No.: US 2009/0310570 A1
(43) Pub. Date: Dec. 17, 2009

(54) Method and Systems Providing Peer-to-Peer Direct-Mode-Only Communications on CDMA Mobile Devices

(75) Inventor: Clint Smith, Warwick, NY (US)

Correspondence Address: The Marbury Law Group, PLLC, 11800 SUNRISE VALLEY DRIVE, SUITE 1000, RESTON, VA, 20191, US

(73) Assignee: Rivada Networks LLC, Crystal City, VA (US)

(21) Appl. No.: 12/485,151

(22) Filed: Jun. 16, 2009

Related U.S. Application Data
(60) Provisional application No. 61/061,883, filed on Jun. 16, 2008.

(51) Int. Cl. H04B 7/216

(52) U.S. Cl. 370/335

(57) ABSTRACT

Embodiments of apparatus, systems and methods enable peer-to-peer direct-mode-only communication within CDMA mobile devices. In an embodiment, peer-to-peer communication is provided via an ad hoc WiFi network connection between two or more mobile devices with sound encoded into data packets using VoIP technology addressed to other members of the ad hoc network. In another embodiment, a modified CDMA transceiver enables mobile devices to receive transmissions from other CDMA mobile devices with peer-to-peer communications identified by a pseudorandom number (PN) offset that differs from the PN offset assigned by the cellular network infrastructure. In another embodiment, a modified CDMA transceiver enables mobile devices to receive transmissions from other CDMA mobile devices on a frequency that is different from the two frequencies employed and CDMA cellular communications. Synchronization of mobile device clock circuits is provided by internal GPS receivers and/or synchronization symbols transmitted by a leader of a communication group.

### RELATED APPLICATIONS

This application claims the benefit of priority to U.S. Provisional Patent Application No. 61/061,883 entitled “Method and Systems Providing Peer-to-Peer Direct-Mode-Only Communications on CDMA Mobile Devices” filed Jun. 16, 2008, the entire contents of which are hereby incorporated by reference.

### FIELD OF THE INVENTION

The present invention relates generally to wireless mobile communication systems, and more particularly to apparatus, methods and systems which provides peer-to-peer communications on CDMA mobile devices.

### BACKGROUND

Emergency services personnel, such as police and fire rescue personnel, often rely upon two-way radios to coordinate actions and call for assistance. Mobile two-way radios are used in broadcast, peer-to-peer and tactical communications group modes. Emergency services personnel may also carry a mobile communication device, such as a cellular telephone, to enable communications outside the broadcast and peer-to-peer communication networks. In some instances, especially where the scale of the emergency is large, cellular telephones can play an important role in command and control communications because of their long range, portability, accessibility, and seamless access to commercial telephone networks. Moreover, nearly all emergency service personnel own a personal cellular telephone or similar mobile device. Consequently, cellular telephones provide the basis for an extensive emergency communication network that does not have to be paid for out of government or community budgets. However, most cellular telephones do not support peer-to-peer communications, and so emergency services personnel must carry both their cellular telephone and a conventional two-way radio in order to accomplish their missions. Thus, there is a need for mobile devices which can provide both cellular telephone connectivity as well as peer-to-peer communication capabilities to reduce the number of communication devices that emergency services personnel must carry.

Cellular telephone communications employ two basic communication technologies: code division multiple access (CDMA) and time division multiple access (TDMA) systems. Examples of CDMA communication systems include, but are not limited to CDMA2000, W-CDMA, and IS-95. Examples of TDMA communication systems include, but are not limited to GSM (Global System for Mobile Communications) and IS-136 or DAMPS.

Conventional CDMA cellular telephones cannot be used for both cellular communications and peer-to-peer direct mode only communications due to the nature of the transmitters and receivers utilized in the system. As illustrated in FIG. 1, in a CDMA telecommunications network communications between a cellular base station 1 and a CDMA cellular telephone 2 are accomplished using two frequencies. For example, using CDMA cellular telephone communications in the AMPS (Advanced Mobile Phone Service) band, transmissions from base stations 1 are transmitted to cellular telephones 2, 3 at 890 MHz, while transmissions from cellular telephones 2 are transmitted to base station antennas 1 at 845 MHz. More generally, message packets transmitted from cellular base stations 1 to CDMA cellular telephones 2, 3 are transmitted on a first frequency (referred to herein and in the drawings as “f₁”), while message packets transmitted from CDMA cellular telephones 2, 3 to cellular base stations 1 are transmitted on a second frequency (referred to herein and in the drawings as “f₂”) 845. CDMA cellular telephones 2, 3 are only able to receive the f₁ frequency transmitted by cellular base stations 1. Thus, when a first CDMA cellular telephone 2 transmits message packets, another CDMA cellular telephone 3 cannot receive those message packets.

The inability to receive message packets from other CDMA cellular telephones is a consequence of their circuit design, an example of which is illustrated in FIG. 2. In a typical CDMA cellular telephone, the antenna 24 is coupled to a transceiver 25 which is coupled to a microprocessor 21 which is coupled to an output speaker 28 and an input microphone 29. The transceiver 25 includes a transmitter circuit 31 which is configured to receive digital data from the processor 21, such as digitally encoded sound received from the microphone 29, and transmit this information via the antenna 24. The transceiver 25 also includes a receiver circuit 32 which is configured to receive an electromagnetic radiation signal from the antenna 24 and convert the received signal into digital data that is conveyed to the processor 21 which, in combination with a vocoder 30 (see FIG. 5) can be translated into analog electrical energy which drives the speaker 28 to output sound. In order to prevent overloading the receiver circuit 32 with energy outputted by the transmitter circuit 31, the transceiver 25 may include a band pass filter 41 which limits the energy received by the receiver circuit 32 to the f₁ frequency (e.g., about 890 MHz for AMPS service) which is the frequency transmitted by cellular base stations 1. Since the receiver circuit 32 and its associated band pass filter 41 are configured so as not to receive the f₂ frequencies (e.g., about 845 MHz for AMPS service) transmitted by the transceiver's transmission circuit 31, one CDMA cellular telephone 2 cannot communicate peer-to-peer in direct mode to another CDMA cellular telephone 3 as illustrated in FIG. 1. Instead, communication from one CDMA cellular telephone to another CDMA cellular telephones must be routed through the base station 1 and the cellular network system.

A number of attempts to provide peer-to-peer direct mode communication capability from cellular telephones have been proposed or implemented. For example, one concept that has been marketed includes an FM transceiver within the CDMA cellular telephone to enable users to communicate by either cellular telephone or FM two-way radio. This approach, however, suffers from the problem that users must select one communication mode or the other, and thus must be out of communication on one network when using the other communication capability. Additionally, communications over the FM two-way radio are transmitted in the clear, and thus can be overheard by anyone monitoring the FM channel. Another concept that has been developed allocates one of the available channels in a GSM cellular network to peer-to-peer communications. However, none of the various attempts to provide peer-to-peer direct mode communication capability from cellular telephones enable near simultaneous cellular and peer-to-peer communications on CDMA cellular telephone.

Peer-to-peer direct mode only communication is different from push-to-talk network systems, such as push-to-talk cellular telephones marketed by Sprint Nextel Corporation. In push-to-talk network systems, communications are routed back to cellular base stations in a dispatch system using radio format. In contrast, peer-to-peer direct mode only communication is from one mobile device direct to another mobile device without the need to communicate via another radio.

### SUMMARY

Various embodiment apparatus, systems and methods provide peer-to-peer direct mode only communications within CDMA mobile devices. In a first embodiment, the mobile device includes a CDMA transceiver used for normal CDMA cellular telephone and data communications, and a wireless network (WiFi) transceiver used to provide peer-to-peer direct mode only communications using voice over Internet (VoIP) technology via an ad hoc WiFi network. In a second embodiment, the mobile device includes a CDMA transceiver having a second receiver circuit configured to receive signals at the same frequency as used by the transceiver's transmitter circuit. In a third embodiment, the mobile device includes a CDMA transceiver having a receiver circuit which is configured to be capable of receiving signals on both the CDMA transmit and receive frequencies. In a fourth embodiment, the mobile device has a transceiver that includes two sets of transmitter and receiver circuits with one set dedicated to cellular telephone communications and the second set dedicated to peer-to-peer direct mode communications. In the various embodiments, the precise time synchronization required in CDMA communications is maintained using timing signals transmitted by cellular base stations, timing signals received by Global Positioning System (GPS) receivers within the mobile devices, and/or synchronization signals generated by one mobile device within a communication group.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention.

FIG. 1 is a system network diagram of a CDMA communication network.

FIG. 2 is a circuit block diagram of a portion of a CDMA mobile device.

FIG. 3 is a system network diagram of a typical broadcast peer-to-peer communication network.

FIG. 4 is a system network diagram of a typical broadcast peer-to-peer communication network with some mobile devices configured to send and receive on tactical communication channels.

FIG. 5 is a component block diagram of an example mobile device suitable for use in the various embodiments.

FIG. 6 is a system network diagram of an embodiment CDMA communication network with peer-to-peer communications provided via a WiFi communication network.

FIG. 7 is a circuit block diagram of a portion of an embodiment CDMA mobile device configured to support the communications network illustrated in FIG. 6.

FIG. 8 is a process flow diagram of method steps that may be implemented in the embodiments illustrated in FIGS. 6 and 7.

FIG. 9 is a system network diagram of another embodiment CDMA communication network with peer-to-peer communications provided via CDMA communication frequencies.

FIG. 10 is a circuit block diagram of a portion of an embodiment CDMA mobile device configured to support the communications network illustrated in FIG. 9.

FIG. 11 is a system network diagram of another embodiment CDMA communication network with peer-to-peer communications provided via CDMA communication frequencies.

FIG. 12 is a circuit block diagram of a portion of an embodiment CDMA mobile device configured to support the communications network illustrated in FIG. 11.

FIG. 13 is a process flow diagram of method steps that may be implemented in the embodiments illustrated in FIGS. 6-12.

FIG. 14 is a system network diagram of another embodiment CDMA communication network with peer-to-peer communications provided via CDMA communication frequencies.

FIG. 15 is a circuit block diagram of a portion of an embodiment CDMA mobile device configured to support the communications network illustrated in FIG. 14.

FIG. 16 is a process flow diagram of method steps that may be implemented in the embodiments illustrated in FIGS. 14 and 15.

FIGS. 17A and 17B are system network diagrams of embodiment CDMA communication networks with peer-to-peer communications capabilities.

FIG. 18 is a process flow diagram of a method for synchronizing communication among CDMA mobile devices according to an embodiment.

FIG. 19 illustrates a data packet for a synchronization symbol for synchronizing CDMA mobile devices according to an embodiment.

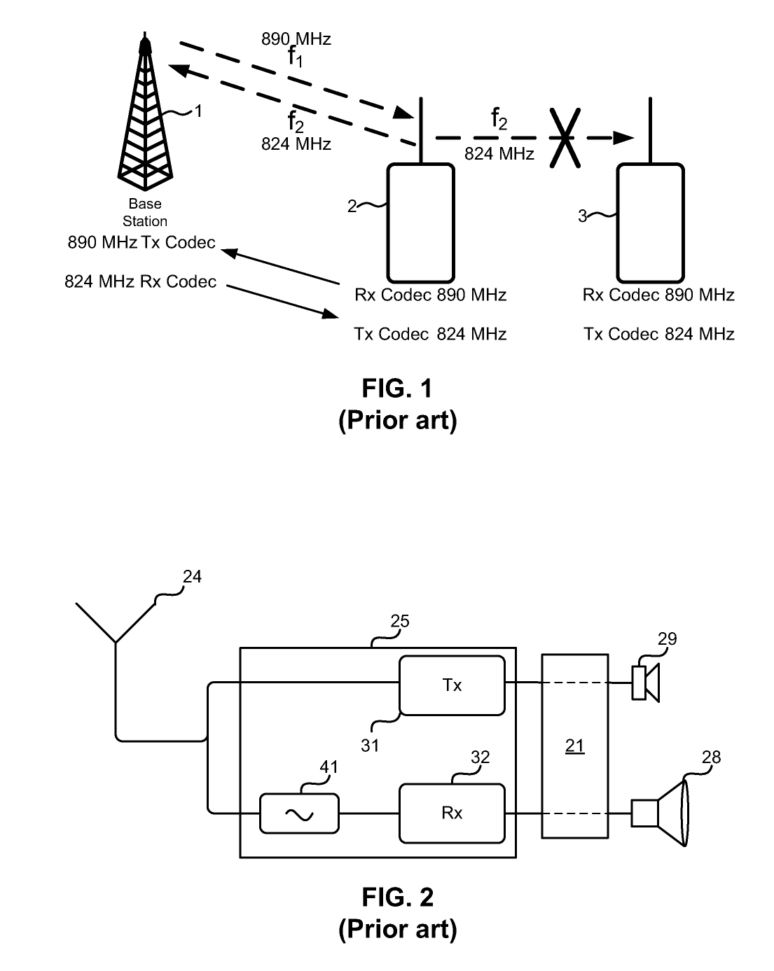

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, the terms “about” or “approximately” for any numerical values or ranges indicates a suitable dimensional tolerance that allows the part or collection of components to function for its intended purpose as described herein.

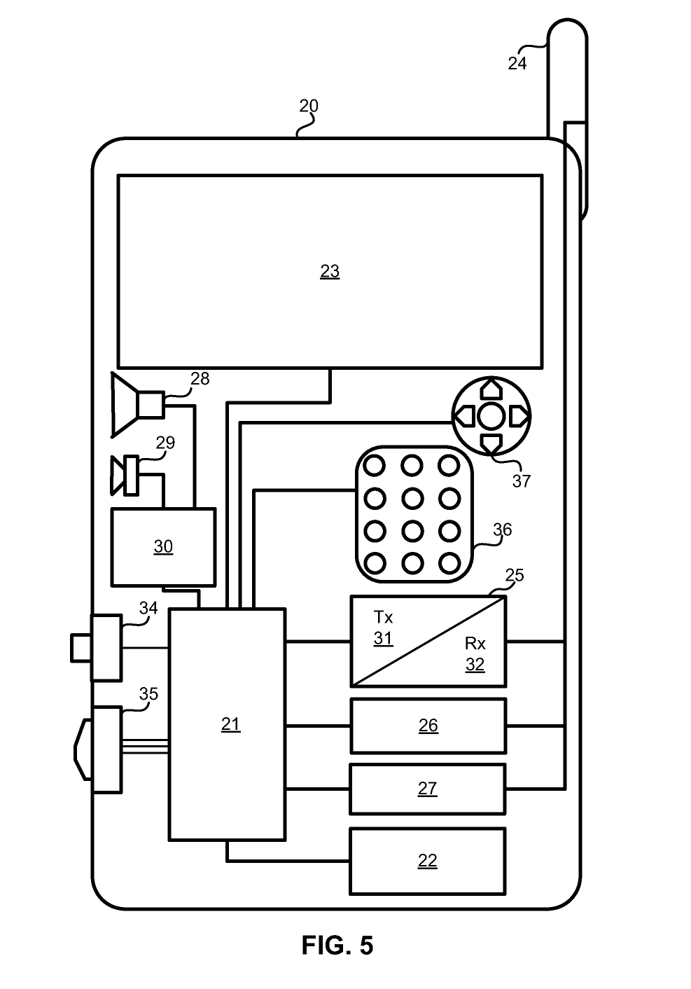

As used herein, the terms “cellular telephone,” “cell phone” and “mobile device” are used interchangeably and refer to any one of various cellular telephones, personal data assistants (PDA's), palm-top computers, laptop computers with wireless modems, wireless electronic mail receivers (e.g., the Blackberry® and Treo® devices), multimedia Internet enabled cellular telephones (e.g., the iPhone®), and similar personal electronic devices. A mobile device may include a programmable processor and memory as described in more detail below with reference to FIG. 5. In a preferred embodiment, the mobile device is a cellular handheld device (e.g., a cellphone), which can communicate via a cellular telephone network.

The various embodiments provide CDMA mobile devices capable of communicating peer-to-peer in direct mode only while maintaining the capability to send and receive CDMA communications. Such embodiments enable emergency services personnel to carry only a single communication device which serves as their day-to-day personal cellular telephone, and which can provide broadcast and peer-to-peer network communications similar to those offered by traditional two-way radios.

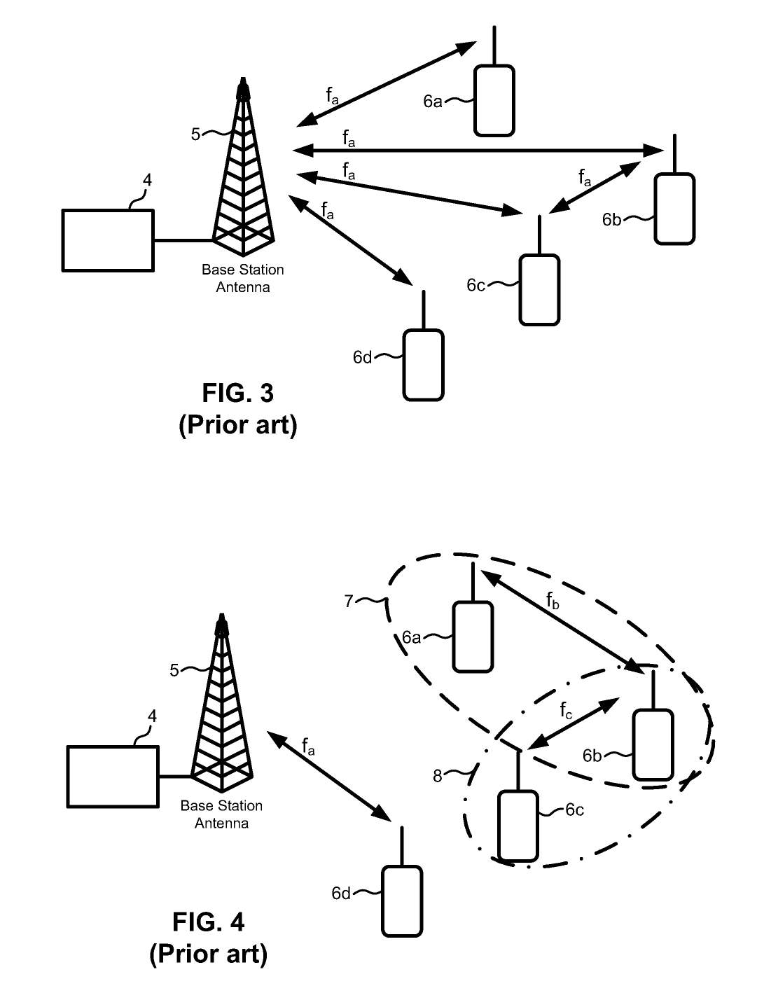

Traditional dispatch and direct mode only communications have proven to be invaluable in police, fire, emergency and military situations where rapid voice communications are required. As illustrated in FIG. 3, in broadcast mode, a single dispatcher within a dispatch facility 4 transmits via a base station antenna 5 a broadcast that can be received by all two-way radios 6a-6d within range. Such broadcast communications ensures the same information is provided to all members tuned into the broadcast frequency (illustrated as frequency fₐ). In this configuration, each two-way radios 6a-6d monitoring the broadcast frequency fₐ receives the same information from the dispatcher 4. Users can also talk peer-to-peer on the same frequency, as illustrated in mobile devices 6b and 6c, however such communications are heard by all mobile devices within range. Broadcast communication networks such as illustrated in FIG. 3 are useful because the same information can rapidly be disbursed to all mobile devices. Similarly, a cry for help from one two-way radios to the dispatcher will also be heard simultaneously by all other two-way radios, thereby permitting rapid response.

However, in many tactical situations, there is a need to establish communication networks among a selected number of emergency service personnel, such as among members of a particular squad or task force. To accommodate such situations, most two-way radios provide the ability to switch frequencies or channels to establish ad hoc communication networks, referred to herein as tactical communication groups, such as illustrated in FIG. 4. Such communication networks are typically established tactically by instructing members of the squad or task force to select a particular radio channel for tactical communications. As illustrated in FIG. 4, as many different tactical communication networks can be established as there are different radio channels available on each of the mobile devices. For example, two-way radios 6a and 6b are shown in a first tactical communication group 7 using radiofrequency f_{b} while two-way radios 6b and 6c are shown in a second tactical communication group 8 using radiofrequency f_{c}. So configured, two-way radios 6a and 6b can be used for voice communications related only to matters of interest to the first tactical communication group without disrupting dispatch communications or denying bandwidth to the second tactical communication group 8 or two-way radios tuned into the broadcast frequency.

While dispatch and tactical communication capabilities offered by two-way radios illustrated in FIGS. 3 and 4 are sufficient in many situations, dispatch communication networks suffer from their inability to enable emergency services personnel to monitor broadcast transmissions while communicating as part of a tactical communications group. As illustrated in FIG. 4, when two-way radios 6a-6c are tuned to respective tactical communication group frequencies f_{b} and f_{c}, they are unable to receive dispatch broadcasts which are transmitted on the dispatch frequency fₐ. In some emergency situations this weakness can be life-threatening, such as when a large number of individuals are tuned to tactical communication networks and emergency instructions, such as orders to evacuate an area or building, are transmitted over the dispatch frequency. Thus, in providing peer-to-peer direct mode only communication capability, it is beneficial to also provide the ability to monitor dispatch and general communication channels.

Cellular telephones are rapidly becoming essential personal appliances. Cellular telephones provide owners with tremendous communication capabilities thanks to the flexibility, reliability and interconnectivity of cellular telephone networks. For these reasons emergency service provider and first responder organizations, such as police, fire and rescue and civil defense departments, are increasingly relying upon cellular telephones as part of their emergency communications networks. Cellular telephones provide the ability to individually address users simply by dialing the proper telephone number. Cellular telephone communications are generally encoded and thus relatively immune from eavesdropping, unlike traditional two-way radios. Cellular telephones also support text, data and video communication capabilities as offered by cellular telephone service providers. Thus, cellular telephones offer significant communication advantages to emergency services personnel.

Even though commercial cellular telephone networks may be unreliable in certain emergency situations (e.g., earthquakes and hurricanes), cellular telephones may nevertheless be relied upon as the backbone for emergency services personnel with the use of supplemental deployable communication units. Such deployable communications units, referred to herein as a “switch on wheels,” can serve as a temporary or auxiliary wireless base station. A switch on wheels may include CDMA2000/EVDO, WCDMA, LTE, IS-136, GSM, WiMax, WiFi, AMPS, DECT, TD-SCDMA, or TD-CDMA and switch, Land Mobile Radio (LMR) interoperability equipment, a satellite Fixed Service Satellite (FSS) for remote interconnection to the Internet and PSTN, and, optionally, a source or remote electrical power such as a gasoline or diesel powered generator. A more complete description of an example deployable switch on wheels is provided in U.S. patent application Ser. No. 12/249,143, filed Oct. 10, 2008 (published as Patent Application Publication No. 2009/0097462 A1 on Apr. 16, 2009), which claims the benefit of priority to U.S. Provisional Application No. 60/979,341 filed Oct. 11, 2007, the entire contents of which are hereby incorporated by reference in their entirety and included as Attachment 1 hereto.

A deployable switch on wheels provides emergency services personnel with a portal to the conventional communications infrastructure that remains unaffected by the emergency. Much like a mobile cellular antenna tower, the switch on wheels provides emergency services personnel with the ability to utilize their conventional cellular telephones even when commercial cellular network infrastructure (e.g., cell towers) has been destroyed. The deployable switch on wheels includes a mobile cellular antenna that can be deployed to act as a temporary cellular tower antenna. The deployable switch on wheels may have a broadcast range approximating that of a conventional cellular tower antenna. The switch on wheels sends and receives communication signals from a plurality of mobile devices and serves as a gateway portal to the rest of the national communications infrastructure. When a communication signal is received by the switch on wheels from one of the plurality of mobile devices, the communication signal may be broken down into packets for transport as a voice-over-Internet-protocol (VoIP) communication. The VoIP communication signal can be transmitted via a satellite owned by a satellite service provider to a ground station far from the emergency where the communication can be forwarded through the Internet to the intended call recipient's telephone number. When a call is made to one of the plurality of mobile devices utilizing the switch on wheels as its local base station, the call is routed to the satellite service provider's router from which the call is sent via satellite relay to the switch on wheels where the call is ultimately forwarded to the intended mobile device.

Depending on the magnitude of the emergency situation, multiple switch on wheels may be deployed to the disaster area. Deploying multiple switch on wheels within a region creates an ad hoc wireless communication network which provides emergency services personnel with adequate network coverage to effectively utilize their cellular telephones until the cellular telephone infrastructure can be returned to service. In long term disaster situations, such as may occur when a coastal region is affected by a major hurricane, the switch on wheels network may remain in place for an extended period of time until conventional communications infrastructure can be repaired or replaced.

While cellular telephones using commercial cellular networks (or a switch on wheels) provides considerable communication infrastructure to emergency services personnel, there is a continued need for peer-to-peer direct mode only communications like those afforded by two-way radios. In providing such peer-to-peer direct mode only communications, the ability to receive broadcast and cellular telephone calls from base stations should also be provided so that tactical communication networks are not effectively cut off from their commanders while monitoring tactical channels. Additionally, communications should be encrypted or otherwise encoded in a manner that makes eavesdropping difficult. Further, such capabilities should be provided in affordable mobile devices that do not require completely new infrastructure.

To meet these requirements, the various embodiments provide mobile devices which communicate using CDMA technologies with the ability to provide both conventional communications with base stations as well as peer-to-peer direct mode only communications with selected peer mobile devices. In an embodiment, mobile devices can communicate peer-to-peer in direct mode only with other mobile devices while continuing to monitor or be able to receive communications from cellular base stations. Tactical communication groups can be set up easily by assigning an appropriate pseudorandom number (PN) offset to all mobile devices within the tactical communication group. In this manner, a number of different tactical communication groups can be established all without interfering with conventional CDMA cellular communications with base stations and the cellular telephone network.

The various embodiments may be implemented in CDMA mobile devices with minor modifications to the circuitry already deployed in commercial cellular telephones. Referring to FIG. 5, a mobile device 20 will typically include a processor 21 coupled to a random access memory 22 and a wireless transceiver 25 coupled to an antenna 24 for sending and receiving voice and data calls via a cellular network. Typical mobile devices also include a rechargeable battery (not shown) which provides power to the processor 21 and transceiver 25, allowing the unit to be portable. The transceiver 25 includes transmitter circuitry 31 and receiver circuitry 32, as described more fully below with reference to FIGS. 7-16. In some implementations, the transceiver 25 and portions of the processor 21 and memory 22 used for cellular telephone communications are referred to as the air interface since the combination provides a data interface via a wireless data link.

The mobile device 20 may include a speaker 28 to produce audible sound and a microphone 29 for sensing sound, such as receiving the speech of a user. Both the microphone 29 and speaker 28 may be connected to the processor 21 via a vocoder 30 which transforms analog electrical signals received from the microphone 29 into digital codes, and transforms digital codes received from the processor 21 into analog electrical signals which the speaker 28 can transform into sound waves. In some implementations, the vocoder 30 may be included as part of the circuitry and programming of the processor 21. The mobile device 20 may also include components typically employed in commercial cell phones, including a display 23, a keyboard 36, and a pointing device or rocker switch 37, all coupled to the processor 21. Further, the mobile device 20 may include a Global Positioning System (GPS) receiver 26, and a WiFi transceiver 27 configured to connect the mobile device 22 local area wireless data networks.

In an embodiment the mobile device 20 may also be configured with a push-to-talk switch or transmission key 34 coupled to the processor 21. This transmission key 34 may be a simple pushbutton which is configured by software instructions executing in the processor 21 to initiate transmission of peer-to-peer communications in a manner similar to that of the push to talk key on two-way radios. In a further embodiment, the mobile device may also be configured with a peer-to-peer communication selector switch 35 coupled to the processor 21. Such a selector switch 35 may be configured by software instructions executing in the processor 21 to enable users to activate the peer-to-peer communication mode and, optionally, select a tactical communication channel. Thus, the selector switch 35 may serve to initiate application software associated with peer-to-peer communications. In an alternative embodiment, the selector switch 35 may be dispensed with by enabling activation of peer-to-peer communication software using option menus presented on the display 23 which are selected by a user activating one or more buttons in the keypad 36 or pressing the rocker switch 37.

The processor 21 may be any programmable microprocessor, microcomputer or multiple processor chip or chips that can be configured by software instructions (applications) to perform a variety of functions, including the functions and process steps of the various embodiments described below. In some mobile devices, multiple processors 21 may be provided, such as one processor dedicated to wireless communication functions and one processor dedicated to running other applications. Typically, software applications may be stored in the internal memory 22 before they are accessed and loaded into the processor 21. In some mobile devices, the processor 21 may include internal memory sufficient to store the application software instructions. For the purposes of this description, the term memory generally refers to all memory accessible by the processor 21, including the internal memory 22, connectable memory chips (e.g., a SIM card), and memory within the processor 21 itself. The internal memory 22 may be volatile or nonvolatile memory, such as flash memory, or a mixture of both.

In the following descriptions of the various embodiments, references to the frequencies used for cellular telephone communications are intended to encompass any and all cellular telephone frequencies currently used, including the 800 MHz AMPS band (which is cited in many examples), the 450 MHz, 700 MHz, 850 MHz bands, the 1710-1755 MHz and 2110-2155 MHz AWS bands (as well as future AWS bands), and the 1.8-2 GHz PCS band, as well as other mobile cellular bands that may be employed in the future. For illustrative purposes, specific AMPS frequencies (namely 890 and 845 MHz) are cited as examples of the f₁ and f₂ frequencies in describing some embodiments. These references to particular frequencies are intended to be illustrative examples only and are not intended to limit the scope of the invention or the claims to particular frequencies, bands or cellular communication protocols unless specifically recited in the claims.

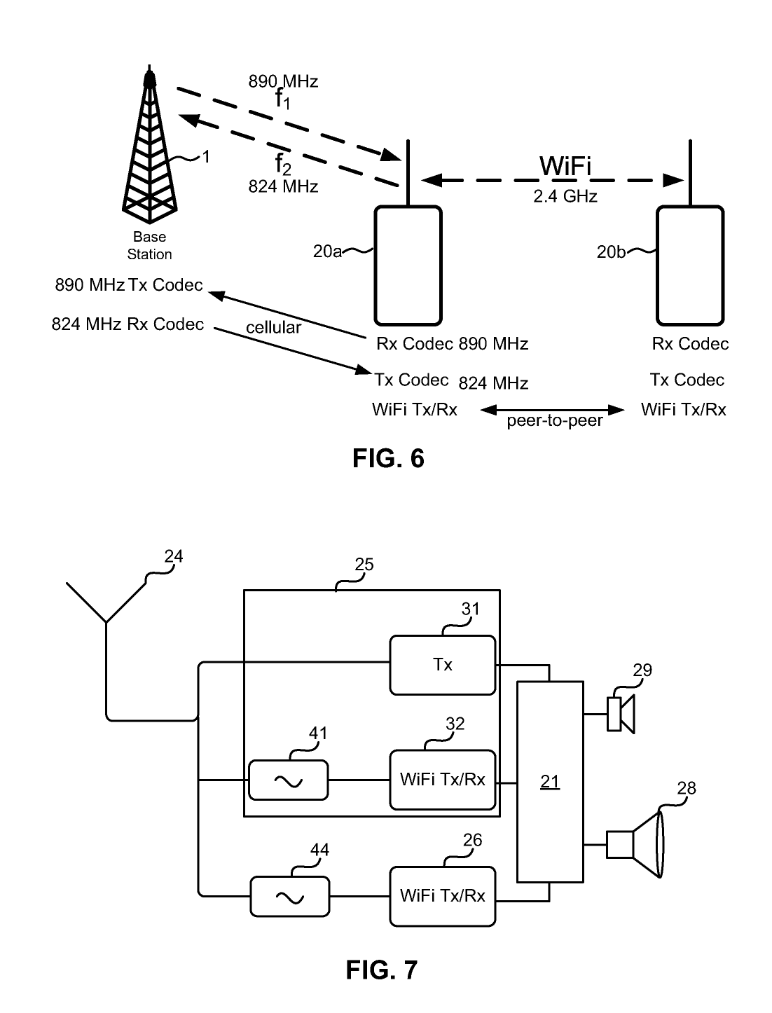

In a first approach, peer-to-peer direct mode only communication is provided by a wireless data network transceiver, referred to as a wireless fidelity (WiFi) transceiver, over an ad hoc WiFi network using voice over IP (VoIP) type technology. The WiFi transceiver may be a wireless network transceiver, such as a transceiver in accordance with the IEEE specification 802.11. A computation system block diagram of this embodiment is shown in FIG. 6, and a circuit block diagram of the communication portions of a mobile device is illustrated in FIG. 7. Many commercially available mobile devices come equipped with a WiFi transceiver 26. Such WiFi transceivers give mobile devices the ability to connect to the Internet via WiFi networks, thus providing Internet access without having to pay for cellular data network service. In this embodiment, the WiFi transceiver 26 is used to communicate with other mobile devices 20a, 20b for the purpose of establishing peer-to-peer direct mode only communications. This leaves the conventional CDMA transceiver 25 available for sending and receiving standard CDMA communications with a base station 1.

Referring to FIG. 6, a mobile device 20a is able to communicate with the base station 1 using standard CDMA frequencies, such as first frequency of approximately 890 MHz for receiving transmissions from the base station (and a second frequency of approximately 845 MHz for communicating to the base station. To effect peer-to-peer communications with another mobile device 20b an ad hoc WiFi network is established between the two mobile devices 20a, 20b. With the ad hoc WiFi network established, voice communications can be provided by converting speech sound into digital data which is packaged into data packets that are transmitted via the WiFi network. Since the WiFi network uses a communication frequency of about 2.4 GHz, which is transmitted and received via a separate WiFi transceiver 26, there is no interference with the basic CDMA communications capabilities of the mobile devices 20a, 20b.

Referring to FIG. 7, the WiFi transceiver 26 is coupled to the processor 21 which is coupled to the speaker 28 and microphone 29. Thus, when communicating in peer-to-peer direct mode only format, speech that is digitally encoded by the vocoder 30 and/or the processor 21, is packaged into WiFi data packets by the processor 21 before being routed to the WiFi transceiver 26 for transmission via the antenna 24. When receiving peer-to-peer direct mode only communications from another mobile device 20b, such transmissions will be received via the common antenna 24 and turned into digital signals by the WiFi transceiver 26 which can be interpreted by the processor 21. Such WiFi packets will include digitized sound generated by the vocoder 30 of the other mobile device 20b, so the processor 21 merely needs to unpack the data payload and pass the received digital sound data to the vocoder 30 to output sound from the speaker 28.

Since the WiFi transceiver 26 shares the same antenna 24 with the CDMA transceiver 25, a filter 44 may be included in the circuits to reduce energy generated by the CDMA transmitter 31 from leaking into the WiFi transceiver 26. Similarly, the band pass filter 41 may be configured to block frequencies of those generated by the WiFi transceiver 26.

To implement this embodiment, the processor 21 is configured with executable software instructions to enable it to generate WiFi packets including digital sound data received from the vocoder 30 and the microphone 29. This software also configures the WiFi data packets to be received by all mobile devices within a particular communication group, such as by means of a proper address appended to each data packet. Thus, the addressing scheme used in WiFi data networks can be used to address encoded sound data packets to particular mobile devices or to all mobile devices within a particular communication group. This provides greater flexibility in establishing tactical communication groups since the address space available to ad hoc WiFi networks can be used to establish multiple communication groups. Since the methods and technologies for encoding sound into digital data, as well as generating and addressing WiFi data packets are well-known in the art, no further explanation of these processes is required to enable those of skill in the art to implement this embodiment.

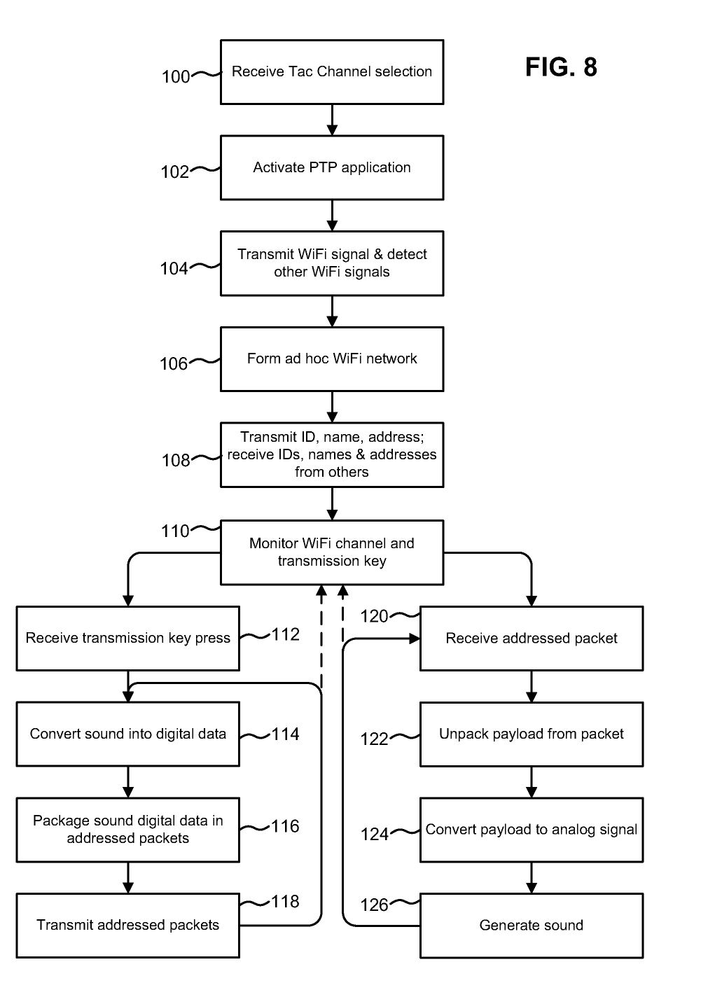

An example of method steps that may be implemented to establish an ad hoc tactical communication group using the embodiment described above with reference to FIGS. 6 and 7 is illustrated in the process flow diagram shown in FIG. 8. Until a peer-to-peer communication network is established, the mobile device may function as a normal cellular telephone. Users may commence peer-to-peer communications by implementing an associated application or, in some implementations, pressing one or more buttons whose functionality is associated with establishing such communications, such as a selector switch 35. Once the peer-to-peer communication functionality is initiated, peer-to-peer transmissions may be initiated by pressing a transmission key 34 or entering a particular tactical communication channel. To set up a tactical communication channel, the user may enter a particular tactical channel selection, such as a number or letter that is used to identify the associated ad hoc WiFi communication network. Upon receiving this user input, step 100, the processor 21 may activate a peer-to-peer communication application (referred to as “PTP” in the figures) if this software is not already running, step 102. The peer-to-peer communication application includes the software instructions that configure the processor 21 to transmit voice data via an ad hoc WiFi network and to convert voice data packets received from the ad hoc WiFi network into sound via the speaker 28. In order to form an ad hoc WiFi network, the processor 21 may transmit network initiation signals via the WiFi transceiver 26 to notify other mobile devices of a desire to establish such a network, as well as listen for similar signals transmitted by other mobile devices, via the WiFi transceiver 26, step 104. Once WiFi signals from other mobile devices have been detected, the processor 21 can send signals to the other mobile devices in order to configure the ad hoc WiFi network, step 106. As part of setting up a network, the processor may transmit its identification, network or group address and the name of its user, for example, while receiving similar information from other mobile devices in the ad hoc WiFi network, step 108. Doing so allows the mobile device to generate a display identifying other members of the ad hoc WiFi communication network. Also, this process step provides the mobile device with addresses necessary to address communication data packets.

With the ad hoc WiFi network established, the processor 21 may monitor the WiFi channel for incoming messages and monitor a transmit key 34 on the mobile device which will be pressed when the user wishes to talk, step 110. When the user presses the transmit key 34, this key press event is received by a processor, step 112, which prompts the processor 21 to begin receiving digitized sound from the microphone 29 and vocoder 30, step 114. Each segment of digitized sound data is packaged into a WiFi network data packet suitable for transmission, step 116, and then transmitted via the WiFi transceiver 26, step 118. The process of converting sound into digital data that is transmitted via the WiFi transceiver, steps 114-118, continues so long as the transmission key 34 remains pressed. In this manner, the mobile device can function like a two-way radio in direct communication mode. Once the transmission key 34 is released, the processor 21 returns to the step of monitoring the WiFi transceiver 26 and the transmission key 34, step 110.

The addressing scheme of an ad hoc WiFi network ensures that addressed packets destined for the mobile device are received while other data packets are rejected. By associating an address with a particular tactical communication group, mobile devices are able to recognize and process only those communication packets associated with the communication group. Thus, the address used to establish an ad hoc wireless network for a tactical communication group serves as an identifier for the group (i.e., a communication group identifier).

When a data packet is received, step 120, that data packet is unpacked in order to obtain the digitized sound data payload, step 122. The digital sound data payload is then converted into an analog signal by the processor and/or vocoder 30, step 124, which is applied to the speaker 28 to generate sound, step 126. The process of receiving data packets, obtaining the digitized sound data payload, converting that data into an analog signal and generating sound, steps 120-126, will continue so long as data packets are received. If there is a gap between incoming data packets the processor 21 returns to the step of monitoring the WiFi transceiver 26 and the transmission key 34, step 110. In the event that the transmission key 34 is depressed at the same time that packets are being received, the processor 21 may buffer (i.e., temporarily store) digital sound data in the memory 22 until there is a gap between incoming data packets at which point the buffered digital sound data may be packetized and transmitted as described above.

While FIG. 8 illustrates a process for receiving sound communication, the ad hoc WiFi network may also be used for sending and receiving text, image and video files from one mobile device to one or more others. Such communication of text, image or video files use well-known methods for transmitting such data via WiFi networks.

In a second approach, peer-to-peer direct mode only communications are provided between mobile devices using standard cellular CDMA frequencies. As mentioned above, any and all cellular telephone frequencies currently used or used in the future may be used in this embodiment. In order to avoid interference with conventional cellular communications between mobile devices and base stations 1, peer-to-peer communications are identified by a pseudorandom number (PN) offset which is different from that used by the nearby base stations 1. This makes use of a feature of CDMA communications used to distinguish individual mobile devices coupled to the network. In CDMA communications, several mobile devices communicate with the same base station 1 using the same downlink (f₁) and uplink (f₂) frequencies. Specifically, transmissions from mobile devices to base stations 1 (the “mobile-to-base station uplink frequency”) use one frequency f₁, which by way of example in the case of CDMA AMPS service is approximately 845 MHz, while transmissions from base stations 1 to mobile devices (the “base station-to-mobile downlink frequency”) use a second frequency f₂, which by way of example in the case of CDMA AMPS service is approximately 890 MHz. CDMA systems transmit on the same RF channel with communications differentiated by PN Offsets. There are 512 PN offset values available for assignment for the RF carrier so that it can be uniquely identified. In addition in CDMA, each mobile has a unique PN code. Using the PN code assigned to a particular mobile device, that device can distinguish message packets transmitted by the base station 1 that are intended for it from message packets intended for other mobile devices. Similarly, the base station 1 can identify the source mobile device of each message packet it receives by both the PN Offset and PN Code so that the message packets can be properly routed. Since most CDMA commercial implementations assign only a portion of the available PN offsets, this leaves a very large number of PN offsets that can be used to identify peer-to-peer and tactical communication group communications for the RF carrier. For example, peer-to-peer communications may be assigned the PN offset of 500, so that there is a low likelihood and that such communications will interfere with commercial CDMA communications.

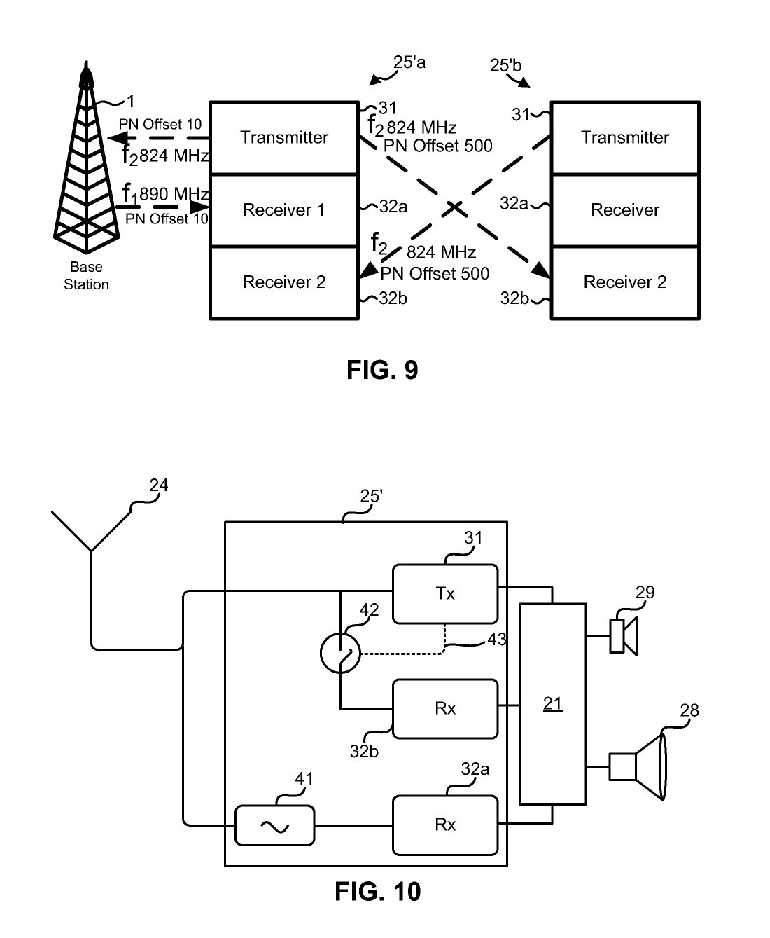

An embodiment implementing this approach is illustrated in FIGS. 9 and 10. In this embodiment, the transceiver 25′ includes two receiver circuits 32a, 32b, with one receiver circuit 32a configured to receive the CDMA base station downlink transmission frequency f₂, (e.g., approximately 890 MHz), and the other receiver circuit 32b configured to receive the standard mobile-to-base station uplink frequency f₂ of transmissions outputted by the transmitter circuit 31 (e.g., approximately 845 MHz). As illustrated in FIG. 9, this configuration enables standard CDMA communications to proceed between the transceiver 25′ and the base station 1 in a conventional manner, with such communications identified by commercially assigned PN offset numbers (such as PN offset 10 as shown in the figure). Simultaneously, peer-to-peer communications may be accomplished between two mobile devices with the transmitted packets produced by a first transceiver 25′a being received by the second receiver circuit 32b within the transceiver 25′b of a second mobile device, and the communications identified by a different PN offset number, such as PN offset 500. Each mobile device configured to recognize and received messages transmitted with PN offset 500, in this example, will receive and process message packets transmitted from each other mobile device configured to transmit messages with the same PN offset. To establish a tactical communication group each member of the group configures their mobile device to transmit and receive tactical communications on a particular PN offset, such as 500 as shown in FIG. 9. So configured, each mobile device can send and receive sound packet data to each other member of the tactical communication group within range while also being able to send and receive cellular communications to/from a cellular base station 1.

FIG. 10 illustrates a circuit diagram of an example embodiment enabling the communication network illustrated in FIG. 9. In this embodiment, the CDMA transceiver 25′ includes a transmitter circuit 31 and two receiver circuits 32a and 32b. The first receiver circuit 32a functions in the conventional manner as described above with reference to FIG. 2. It may include a band pass filter 41 configured to allow f₁ frequencies of the base station transmitter (e.g., ˜890 MHz) to pass while blocking f₂ frequencies outputted by the transmitter circuit 31 (e.g., ˜845 MHz). The second receiver circuit 32b within the transceiver 25′ is configured to receive the same f₂ frequencies as outputted by the transmitter circuit 31 (e.g., ˜845 MHz) so that it may receive and process communications from other mobile devices. In order to protect the second receiver circuit 32b, a transmission cutout switch 42 may be coupled between the receiver circuit and the common antenna 24. The transmission cutout switch 42 may be configured with a control lead 43 tied to the transmitter circuit 31, as illustrated, or the processor 21 and configured so that when the transmitter circuit 31 is transmitting the transmission cutout switch 42 is open. The transmission cutout switch 42 may be a transistor or transistor-base switch circuit with the source and drain connected to the antenna 24 and the receiver circuit 32b, and the gate connected to the control lead 43. This transmission cutout switch 42 prevents transmission energy from entering the second receiver circuit 32b, thereby reducing the potential for cross-talk, simplifying the second receiver circuit 32b circuit design, and reducing parasitic losses of transmission power. The second receiver circuit 32b converts signals received from other mobile devices into digital data that is provided to the processor 21 where the data are processed in a manner very similar to data generated by the first receiver circuit 32a.

The circuit illustrated in FIG. 10 enables a CDMA mobile device 20 to send and receive peer-to-peer direct mode only communications to/from other so configured mobile devices (with such communications being received by the second receiver circuit 32b) while also being able to receive conventional CDMA communications from base stations 1 (with such communications being received by the first receiver circuit 32a). The processor 21 and/or the two receiver circuits 32a, 32b may be configured to recognize messages with the PN offset assigned by the base station, as well as the PN offset selected for peer-to-peer communications.

As illustrated in FIG. 10, the first and second receiver circuits 32a, 32b may be packaged within a single transceiver 25′ chip. However, the second receiver circuit 32b may be configured as a separate integrated circuit coupled to the common antenna 24, and the processor 21, as well as the transmitter circuit 31 for the transmission cutout switch control lead 43.

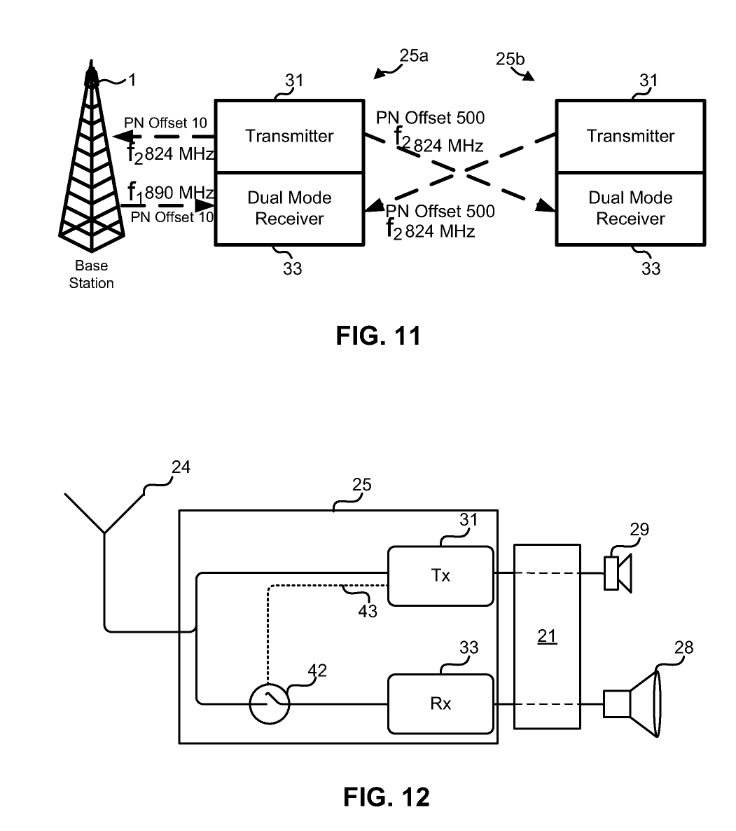

An alternative embodiment for implementing the second approach is illustrated in FIGS. 11 and 12. In this embodiment, the transceiver 25 includes a transmitter circuit 31 and a dual-mode receiver circuit 33. The dual-mode receiver circuit 33 is configured to receive and process signals on two frequencies, namely the downlink transmission frequency f₁ of base stations 1 (e.g., ˜890 MHz) and the standard mobile-to-base station uplink transmission frequency f₂ outputted by the transceiver transmitter circuit 31 (e.g., ˜845 MHz). Thus, a dual-mode receiver circuit 33 is able to receive and process transmissions from other mobile devices. Transmissions between mobile devices are distinguished from transmissions between mobile devices and the base station 1 by means of a different PN offset as described above with reference to FIG. 9. Thus, in a manner similar to that of the embodiment described above with reference to FIG. 9 and 10, mobile devices are able to send and receive messages both to other mobile devices and to base stations without the two communications interfering with each other. Similarly, tactical communication groups can be established simply by assigning a common PN offset to all mobile devices within the group.

FIG. 12 illustrates a circuit diagram of an example embodiment enabling the communication network illustrated in FIG. 11. In this embodiment, the CDMA transceiver 25 includes a transmitter circuit 31 and a dual-mode receiver circuit 33. The dual-mode receiver circuit 33 receives the f₁ transmission frequencies of base stations 1 (e.g., f₁˜890 MHz) and functions in the conventional manner as described above with reference to FIG. 2. The dual-mode receiver circuit 33 may also be configured to receive the same standard mobile-to-base station uplink frequency f₂ as outputted by the transmitter circuit 31 (e.g., f₂˜845 MHz) so that it may receive and process communications from other mobile devices. In order to protect the dual-mode receiver circuit 33 from receiving and processing transmissions from its associated transmitter circuit 31, a transmission cutout switch 42 may be coupled between the receiver circuit and the common antenna 24. Similar to the embodiment described above with reference to FIG. 10, the transmission cutout switch 42 may be a transistor circuit configured with a control lead 43 tied to the transmitter circuit 31, as illustrated, or the processor 21 configured so that when the transmitter circuit 31 is transmitting the transmission cutout switch 42 is open. This prevents transmission energy outputted by the transmitter circuit 31 from entering the dual-mode receiver circuit 33, thereby reducing the potential for cross-talk, simplifying the dual-mode receiver circuit 33 design, and reducing parasitic losses within the transceiver 25. The dual-mode receiver circuit 33 converts signals received from other mobile devices into digital data that is provided to the processor 21 where the data are processed in a manner very similar to those generated in response to receptions of signals from base stations 1.

The circuit illustrated in FIG. 12 enables a CDMA mobile device 20 to send and receive peer-to-peer direct mode only communications to/from other so configured mobile devices while also being able to receive conventional CDMA communications from base stations 1, with the respective communications being distinguished based upon PN offset. The processor 21 and/or the dual-mode receiver circuit 33 may be configured to recognize messages with the PN offset assigned by the base station, as well as the PN offset selected for peer-to-peer communications.

The dual-mode receiver circuit 33 is an extension of the present CDMA transceiver technology. As is well known, CDMA transceiver's monitor multiple frequencies in order to detect alternative networks and base stations to support movement within and between cellular networks. The embodiment illustrated in FIG. 12 extends this capability to include the standard mobile-to-base station uplink frequency f₂ used by mobile device transmitters (e.g., f₂˜845 MHz). In addition, the transmission cutout switch 42 is provided in order to enable the dual-mode transceiver 33 to monitor transmissions from other mobile devices while avoiding crosstalk with the transmitter circuit 31. As result of the use of a transmission cutout switch 42, the normal functioning of the mobile device may be affected as the transceiver 25 will not be a true duplex transceiver. Thus, while talking on a mobile device implementing the transceiver 25 illustrated in FIG. 12, there may be clipping or chirping of the signals received at the same time that a caller is speaking. However, such affects may be mitigated by proper timing of transmission packets and operation of the transmission cutout switch 42.

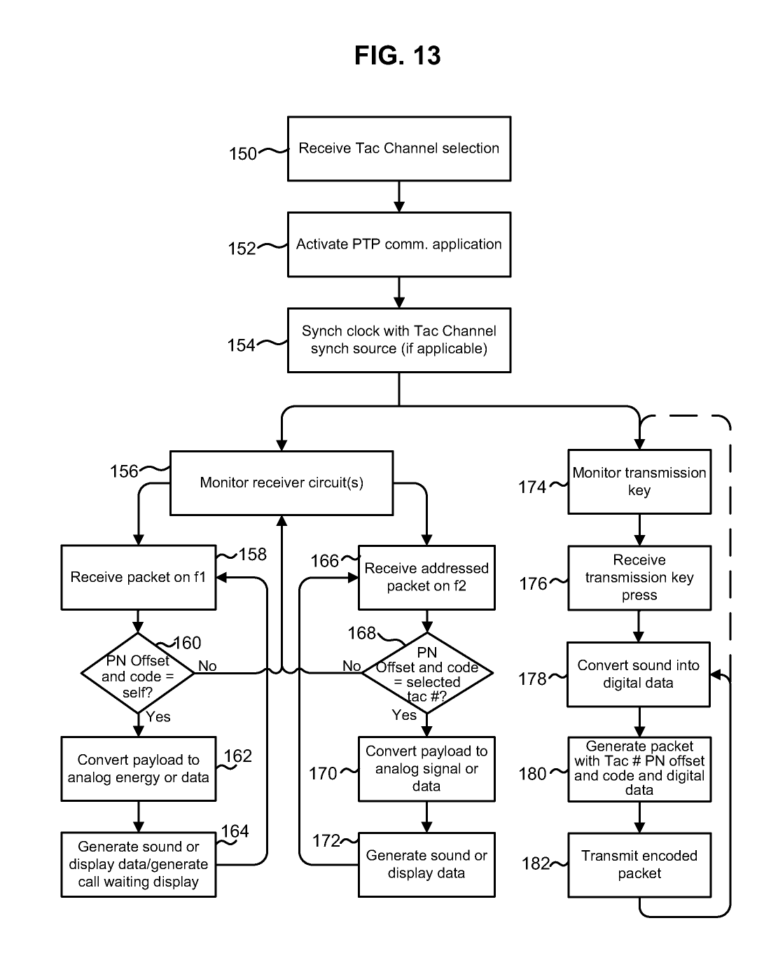

An example of method steps that may be implemented to establish a tactical communication group using the embodiments described above with reference to FIGS. 9-12 is illustrated in the process flow diagram shown in FIG. 13. When a mobile device according to the embodiments illustrated in FIGS. 9-12 is not in a tactical communication mode, it may function in the conventional manner of any cellular telephone. To commence peer-to-peer direct mode only communication, a user may select a tactical channel or configure the mobile device to begin conducting such communications. The mobile device may be configured by means of a user interface menu that allows a user to select peer-to-peer communications and identify a particular tactical channel. Alternatively, the mobile device may be configured with one or more buttons or switches with functionality associated with initiating peer-to-peer communications. For example, a mobile device may be configured with a selector switch 35 that initiates the peer-to-peer communications mode by activating an associated software application. Such a selector switch 35 may include two or more positions associated with particular tactical channels which configure the mobile device to transmit and receive peer-to-peer communications using a particular PN offset (e.g., 500 as illustrated in the figures).

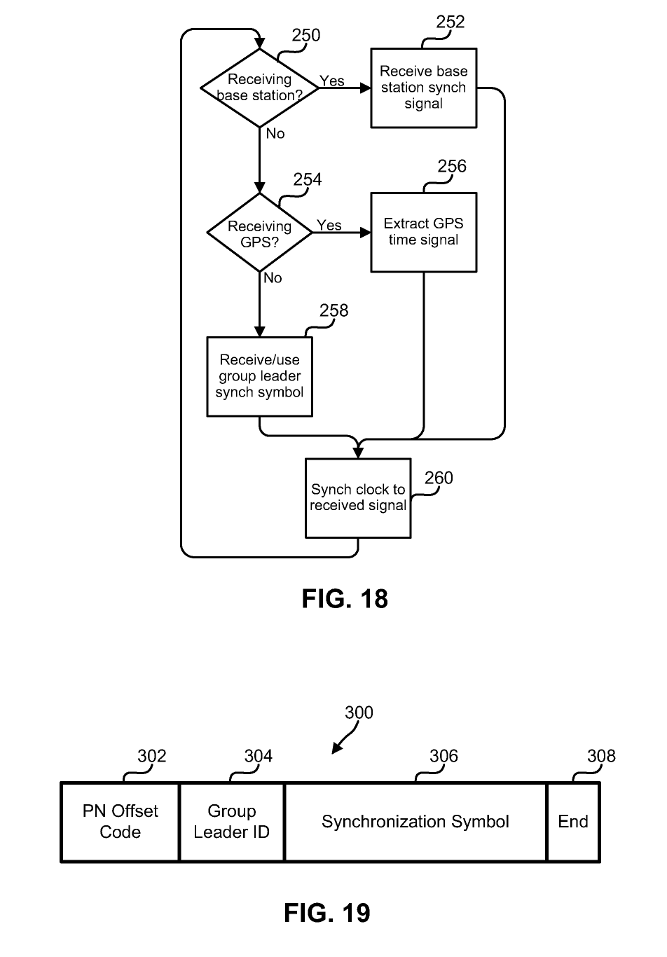

Referring to FIG. 13, when a user interacts with the mobile device to identify a particular tactical channel, such as by positioning a selector switch 35, that selection is received by the processor, step 150. This selection may activate a peer-to-peer communication application if that application is not already activated, step 152. Since CDMA communications requires synchronization of data packets and transmission waveforms, the processor 21 may need to synchronize its internal clock with timing synchronization pulses associated with the tactical channel (in some circumstances), step 154. The process of synchronizing clocks with those of the tactical channel are described in more detail below with reference to FIG. 18.

With the peer-to-peer communications mode initiated and the internal clock synchronized with those of other mobile devices, the processor 21 can begin to monitor the receiver circuits 32, 33 to detect incoming transmissions, step 156, and monitoring the transmission key 34 to detect a user's desire to begin transmitting, step 174. If the receiver circuit 32, 33 receives an incoming packet transmitted on the f₁ downlink transmission frequency of CDMA cellular base stations 1 (e.g., f₁˜890 MHz), step 158, the receiver circuit 32 or the processor 21 may test whether the PN offset in the received packet matches the PN offset and code assigned to the mobile device, test 160. If the PN offset and code does not match that assigned to the mobile device (i.e., test 160=“No”), the received packet is ignored and the processor 21 returns to the state of monitoring the receiver circuit(s), returning to step 156. However, if the PN offset matches that assigned to the mobile device (i.e., test 160=“Yes”), that payload is processed by the processor 21 and the vocoder 30 to obtain the encoded sound data and convert that information into an analog signal, step 162, which is applied to the speaker 28 to generate sound, step 164. In some cases, the incoming packet may contain text or other data, such as information for an SMS message, in which case the processor 21 obtains this information from the packet payload and converts it into processable data, step 162, which may be then presented on a display, step 164. Once the received packet has been processed the processor 21 returns to the state of monitoring the receiver circuit(s), returning to step 156. If the transmission key 34 is depressed while an incoming data packet is being received from a base station, the digitized sound data may be buffered in memory until there is a gap between incoming data packets at which point the buffered digital sound data may be transmitted to a tactical communication group as described below (i.e., identified with the PN offset assigned to the communication group) and not to base station.

If the receiver circuit 32, 33 receives an incoming packet transmitted on the transmission frequency of CDMA mobile devices (i.e., frequency f₂), step 166, the processor 21 will test whether the PN offset and code in the received packet matches the PN offset and code assigned to the tactical communication group selected on the mobile device, test 168. If the PN offset does not match that assigned to the tactical communication group of which the mobile device is a member (i.e., test 168=“No”), the received packet is ignored as the packet is intended for a different tactical communication group, and the processor returns to the state of monitoring the receiver circuit, returning to step 156. However, if the PN offset matches that assigned to the communication group of which the mobile device is a member (i.e., test 168=“Yes”), the payload of the received packet is processed by the processor 21 and the vocoder 30 to obtain the encoded sound data and convert that information into an analog signal, step 170, which is applied to the speaker 28 to generate sound, step 172. In some implementations, text data may also be transmitted within a tactical communication group in a manner similar to that of SMS messaging. In such implementations, the incoming packet may contain text or other data, in which case the processor 21 obtains this information from the packet payload and converts it into processable data, step 170, which may then be presented on a display, step 172. Once the received packet has been processed, the processor 21 returns to the state of monitoring the receiver circuit(s), returning to step 156. If the transmission key 34 is depressed while an incoming data packet is being received from a base station, the digitized sound data may be buffered in memory until there is a gap between incoming data packets at which point the buffered digital sound data may be transmitted to a tactical communication group as described below.

If the mobile device detects the press of a transmission key 34, step 176, this indicates that the user desires to begin speaking for transmission to the tactical communications group. In response to receiving the transmission key press, the processor 21 causes the vocoder 30 to begin converting sound received via the microphone 29 into digital data, step 178. The process of converting sound into digital sound data is the same as that implemented via the mobile device for normal cellular telephone communications, and thus implements well known technology. The processor generates a transmission packet containing the digital sound data that is encoded with the PN offset and code of the tactical communication group, step 180. Again, the generation of this packet and the attachment of the PN offset and code implement the same technologies as used in conventional CDMA cellular telephone communications. The generated packet is then transmitted by the transmitter circuit 31 in the same manner as conventional CDMA cellular telephone communications, step 182. The process of converting sound into digital data and transmitting packets to the tactical communication group, steps 178-182, continues so long as the transmission key 34 remain suppressed. Once the transmission key 34 is released, the processor 21 returns to the state of monitoring the transmission key 34, returning to step 174.

In order to permit the mobile device to monitor transmissions from base stations 1, the processor 21 may be configured with software to display a call waiting presentation on the mobile device display, step 164, when a packet is received on the base station frequency f₁ at the same time that transmissions are being received on the mobile device frequency f₂ or the user is transmitting to the tactical communication group by holding down the transmission key 34, step 176. In this matter, even with active communication proceeding with a tactical communication group, a user will be in informed that a call is waiting or a broadcast is being received from a dispatcher.

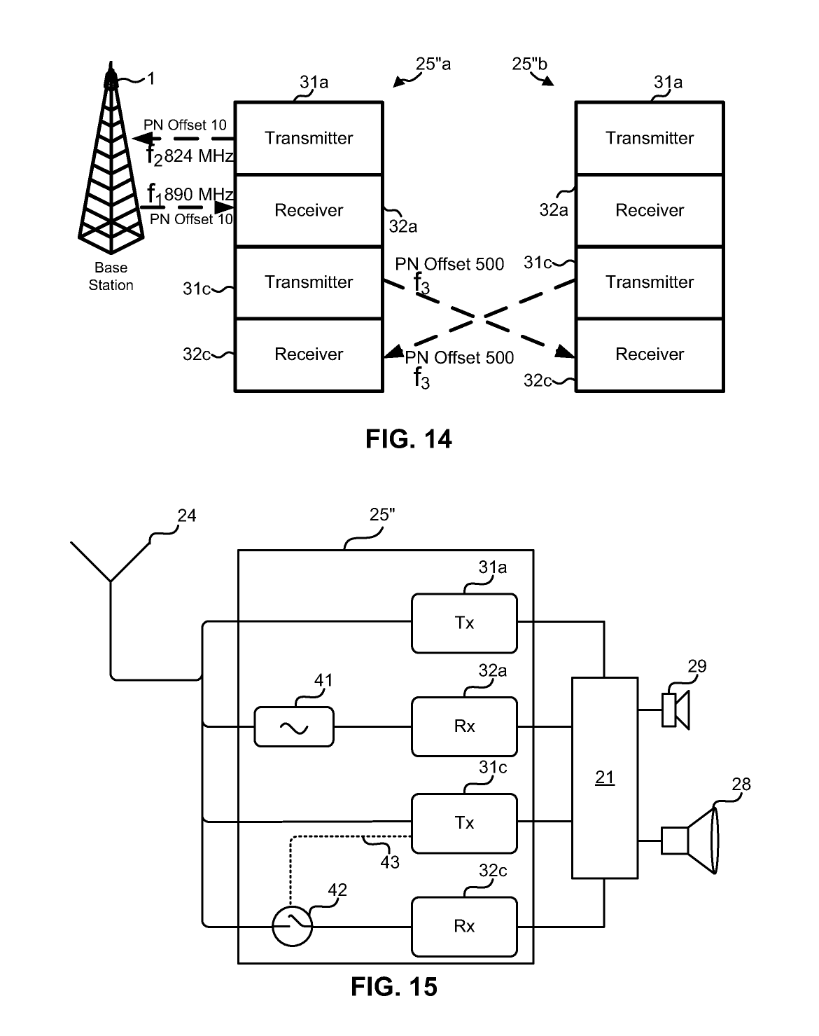

In a third approach, peer-to-peer CDMA communications are provided on a different set of transmission and receive frequencies than conventional CDMA cellular communications. This approach allows cellular communications with base station antennas 1 to proceed in parallel with peer-to-peer communications with other mobile devices within a communication group. An embodiment for implementing this approach is illustrated in FIGS. 14 and 15.

Referring to FIG. 14, a communication system using this embodiment involves mobile devices equipped with transceivers 25″ that include two transmitter circuits 31a, 31c and two receiver circuits 32a, 32c. A first set of transmitter and receiver circuits 31a, 32a are configured to send and receive data packets using cellular communication frequencies f₁, f₂, such as for example transmitting at approximately 845 MHz and receiving at approximately 890 MHz. These transmitter and receiver circuits 31a, 32a enabled the mobile device to engage in conventional CDMA cellular telephone communications. Additionally, the mobile device transceiver 25″ includes a second set of transmitter and receiver circuits 31c, 32c which are configured to send and receive data packets using a different frequency f₃. In addition to distinguishing peer-to-peer communications based upon frequency, the communications may also be identified by a PN offset in the same or similar manner as conventional CDMA communications. For example, as illustrated in FIG. 14, a tactical communication group may be assigned the PN offset of 500. This enables a large number of tactical communication groups to be established by assigning different PN offset numbers. The communication architecture and mobile devices illustrated in FIG. 14 enables mobile devices to send and receive tactical communications using peer-to-peer direct mode only communications while simultaneously monitoring and receiving conventional CDMA cellular telephone communications. Thus, this embodiment integrates the functions and features of CDMA cellular telephones with the functionality associated with familiar two-way radios.

FIG. 15 illustrates a circuit diagram of an example embodiment enabling the communication network illustrated in FIG. 14. In this embodiment, the CDMA transceiver 25″ includes a first transmitter circuit 31a and a first receiver circuit 32a that are coupled to the common antenna 24 and to the processor 21 in a manner similar to that of a conventional CDMA transceiver. The receiver circuit 32a may be coupled to a band pass filter 41 configured to allow transmission of frequencies from the antenna 24 which are within a narrow band around the CDMA base station transmission downlink frequencies f₁ (e.g., approximately 890 MHz). Additionally, the CDMA transceiver 25″ includes a second transmitter circuit 31c and a second receiver circuit 32c that are also coupled to the common antenna 24 and to the processor 21. The second transmitter circuit 31c is configured to transmit at a frequency f₃ different from that of the CDMA base station-to-mobile downlink frequency f₁ and the mobile-to-base station uplink f₂ frequency (e.g., different from 890 MHz and 845 MHz). For example, the second transmitter circuit 31c may be configured to transmit on another CDMA carrier f₃. The transmitter circuit 31c may be provided with data packets by the processor 21 in a very similar manner as that of the conventional transmitter circuit 31a, specifically via the same microphone 29 and vocoder circuit 30. The second receiver circuit 32c is configured to receive signals at the same frequency f₃ as transmitted by the second transmitter circuit 31c. A transmission cutout circuit 42 may be provided between the common antenna 24 and the second receiver circuit 32c in a manner very similar to that described above with reference to FIGS. 10 and 12. As described above with reference to FIGS. 10 and 12, the transmission cutout circuit 42 may be a transistor or transistor-base switch circuit with a control lead coupled to the second transmitter circuit 31c or the processor 21 that is configured to block transmission of radiation to the second receiver circuit 32c whenever the transmitter circuit 31c is transmitting. The second receiver circuit 32c is connected to the processor 21 in a manner similar to that described above with reference to FIG. 10 for the receiver circuit 32b. Thus, the same processor functions, vocoder 30 and speaker 28 used for conventional CDMA communications can be used with the second receiver circuit 32c for receiving peer-to-peer communications on frequency f₃.

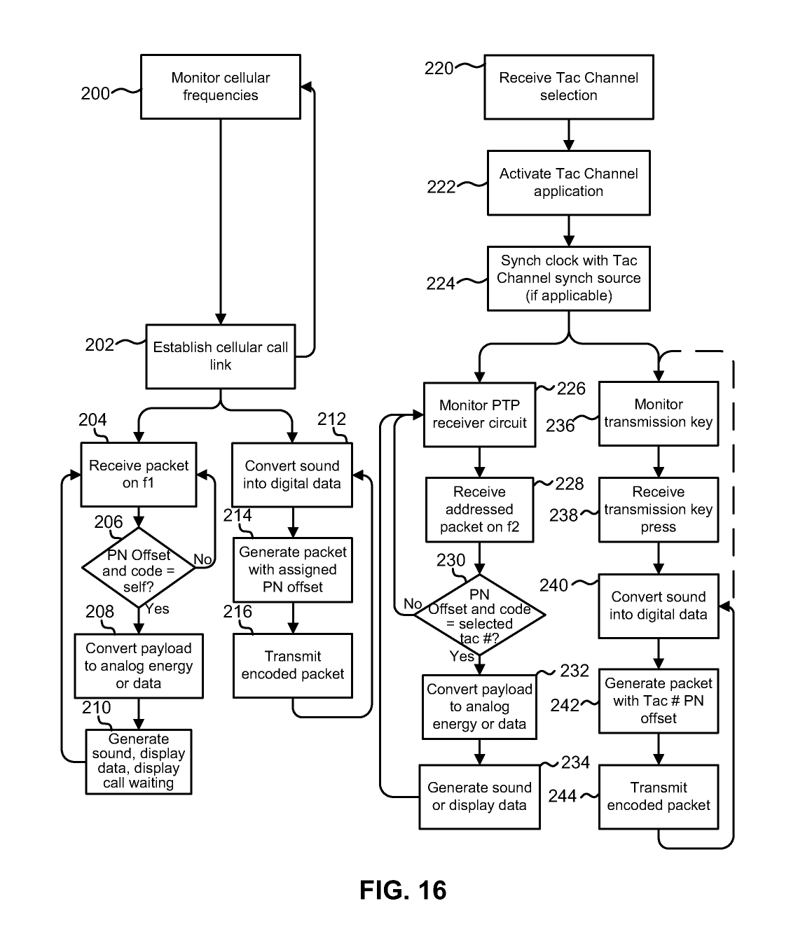

An example of method steps that may be implemented in the embodiment illustrated in FIGS. 14 and 15 is illustrated in the process flow diagram shown in FIG. 16. With mobile devices configured with two parallel transmitter and receiver circuits within the transceiver 25″ the mobile devices can maintain both CDMA cellular communications and peer-to-peer direct mode only communications in parallel. The mobile device may continually monitor the cellular frequencies to detect an incoming phone call, step 200. Upon receiving an in coming telephone call, a user may answer the call by pressing a call answer button (e.g., the Send key) to establish a cellular telephone call communication link, step 202. Alternatively, users may dial a number and press the Send key in order to establish a cellular telephone call communication link, step 202. The cellular telephone call can then proceed in the conventional manner. For example, when the receiver circuit 32a receives an incoming packet transmitted on the transmission frequency of CDMA cellular base stations 1 (i.e., frequency f₁), step 204, the receiver circuit 32a or the processor 21 may test whether the PN offset and code in the received packet matches the PN offset and code assigned to the mobile device, test 206. If the PN offset and code does not match that assigned to the mobile device (i.e., test 206=“No”), the received packet is ignored and the processor 21 returns to receiving the next packet, returning to step 204. However, if the PN offset and code matches that assigned to the mobile device (i.e., test 206=“Yes”), that payload is processed by the processor 21 and the vocoder 30 to obtain the encoded sound data and convert that information into an analog signal, step 208, which is applied to the speaker 28 to generate sound, step 210. In some cases (when a cellular call is not taking place), the incoming packet may contain text or other data, such as information for an SMS message, in which case the processor 21 obtains this information from the packet payload and converts it into processable data, step 208, which may be then presented on a display, step 210. Once the received packet has been processed the processor 21 returns to receiving the next packet, returning to step 204, and the process continues so long as the call remains active.

In parallel with receiving CDMA packets, the microphone 29 receives sound, such as a user's speech, which is converted into digital data by the vocoder 30 that is provided to the processor 21, step 212. Using the digital sound data the processor 21 generates data packets for transmission including the PN offset and code that was assigned to the mobile device by the cellular base station 1 with which the mobile device is communicating, step 214. These packets are then transmitted via the transmitter circuit 31a. This process of converting sound into digital data that is transmitted in data packets, steps 212-216, continues so long as the call remains active.

Once a cellular call is terminated, the processor 21 returns to the state of monitoring cellular frequencies for incoming calls, returning to step 200.

When a user interacts with the mobile device to identify a particular tactical channel, such as by positioning a selector switch 35, that selection is received by the processor, step 220. This selection may activate a peer-to-peer communication application if that application is not already activated, step 222. Since CDMA communications requires synchronization of data packets and transmission waveforms, the processor 21 may need to synchronize its internal clock with timing synchronization pulses associated with the tactical channel in some circumstances, step 224. The process of synchronizing clocks with those of the tactical channel are described in more detail below with reference to FIG. 18.

With the peer-to-peer communications mode initiated and the internal clock synchronized with those of other mobile devices, the processor 21 can begin to monitor the second receiver circuit 32c to detect incoming transmissions, step 226, and monitoring the transmission key 34 to detect a user's desire to begin transmitting, step 236. If the second receiver circuit 32c receives an incoming packet transmitted on the peer-to-peer frequency (i.e., frequency f₃), step 228, the second receiver circuit 32c or the processor 21 will test whether the PN offset and code in the received packet matches the PN's assigned to the tactical communication group selected on the mobile device, test 230. If the PN offset and code does not match that assigned to the tactical communication group of which the mobile device is a member (i.e., test 230=“No”), the received packet is ignored as the packet is intended for a different tactical communication group, and the processor returns to the state of monitoring the receiver circuit, returning to step 226. However, if the PN offset matches that assigned to the communication group of which the mobile device is a member (i.e., test 230=“Yes”), the payload of the received packet is processed by the processor 21 and the vocoder 30 to obtain the encoded sound data and convert that information into an analog signal, step 232, which is applied to the speaker 28 to generate sound, step 234. In some implementations, text data may also be transmitted within a tactical communication group in a manner similar to that of SMS messaging. In such implementations, the incoming packet may contain text or other data, in which case the processor 21 obtains this information from the packet payload and converts it into processable data, step 232, which may then be presented on a display, step 234. Once the received packet has been processed, the processor 21 returns to the state of monitoring the second receiver circuit, returning to step 226.

If the mobile device detects the press of a transmission key 34, step 238, this indicates that the user desires to begin speaking for transmission to the tactical communications group. In response to receiving the transmission key press, the processor 21 causes the vocoder 30 to begin converting sound received via the microphone 29 into digital data, step 240. The process of converting sound into digital data is the same as that implemented via the mobile device for normal cellular telephone communications. The processor 21 generates a transmission packet encoded with the PN code of the tactical communication group, step 242. Again, the generation of this packet and the attachment of the PN offset and code implement technologies similar to those used in conventional CDMA cellular telephone communications. The generated packet is then transmitted by the second transmitter circuit 31c, step 244. The process of converting sound into digital data and transmitting packets to the tactical communication group, steps 240-244, continue so long as the transmission key 34 remain depressed. Once the transmission key 34 is released, the processor 21 returns to the state of monitoring the transmission key 34, returning to step 236.

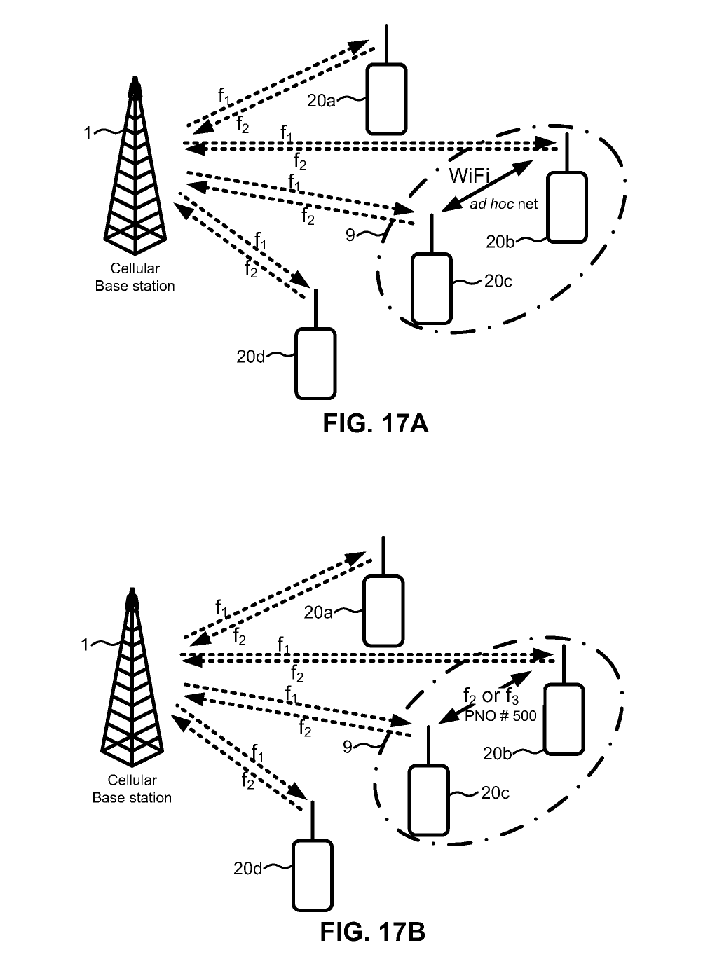

The embodiment described above with reference to FIGS. 6-8 enables a flexible communication architecture such as illustrated in FIG. 17A. In this architecture, mobile devices 20a-20d are able to communicate with the base station 1 while also being able to engage in peer-to-peer direct mode only communications via a separate WiFi ad hoc network 9. Thus, while mobile devices 20b and 20c can be engaged in peer-to-peer communications, they remain accessible to cellular telephone calls. FIG. 17A also illustrates how communications with individual mobile devices using WiFi frequencies and transceivers enables communications within the transmission range of a typical WiFi transceiver included in mobile devices.

Similarly, the embodiments described above with reference to FIGS. 9-16 enable a flexible communication architecture such as illustrated in FIG. 17B. In this communication architecture, mobile devices 20a-20d are able to communicate with the base station 1 while also being able to engage in peer-to-peer direct mode only communications using CDMA frequencies (i.e., f₂) or CDMA encoding over a third frequency (i.e., f₃). Thus, while mobile devices 20b and 20c can be engaged in peer-to-peer communications within a tactical communication group 9 distinguished by their mutual PN offset #500 (as well as frequency f₃ in one embodiment), and PN Codes they remain accessible to cellular telephone calls. Using CDMA frequencies and transceivers, this communication architecture enables communications within the typical transmission range of a typical CDMA mobile device for normal communications and up to several miles for peer to peer, DMO, communications.

In a variation of the foregoing embodiments, one or more of the mobile devices within a communication group may be configured to monitor communications among multiple communication groups. CDMA receivers are capable of monitoring more than one PN offset on the same RF channel as is necessary to enable smooth handoffs between communication cells. Using this capability, a mobile device may be configured to receive and process messages with multiple communication group PN offsets simultaneously. This embodiment enables one (or more) mobile device to listen in to communications going on over multiple communication groups. This embodiment may be useful for task force and on-scene commanders responsible for personnel in multiple communication groups. This embodiment may also be useful for monitoring and recording all communications happening within a particular area. This embodiment is enabled by configuring the processor 21 with software to accept multiple PN offset values, such as multiple PN offsets that are selected by the user using a user interface (e.g., a menu presented on the display 23).

In order to enable the decoding of CDMA transmissions by mobile devices, each transmitter and receiver must be tightly synchronized to a common time standard. To enable such synchronization, circuitry within the mobile device includes a precise clock circuit (i.e., clock) that the processor 21 and transceiver 25 utilized for recognizing, decoding and transmitting data packets. Since even a very precise clock circuit will drift, mobile devices and base station transceivers will quickly fall out of sync unless there is a mechanism for periodically synchronizing clocks in all devices coupled to the same cellular network. In commercial CDMA cellular networks this synchronization is provided by timing signals issued periodically by the cellular base stations 1. All mobile devices in communication with a base station then synchronize their internal clock circuits to match that of the base station 1.

The various embodiments may not be able to rely upon time synchronization signals received from commercial cellular networks. This is because emergency response personnel often need to communicate when they are in situations where cellular communications are not available. For example, cellular signals do not penetrate all buildings and are not available in underground locations, such as subways and tunnels. Also, in some situations commercial cellular network infrastructure may be temporarily unavailable due to the nature of the emergency, such as an earth quake or hurricane. Accordingly, other mechanisms need to be used in order to synchronize the clock circuits of all mobile devices within tactical communication groups. To provide this capability, the various embodiments employ precise timing signals that may be obtained from embedded GPS receivers and/or timing signals generated by one member of a tactical communication group.

FIG. 18 illustrates a process flow that may be implemented in mobile devices to ensure each mobile device within a communication group is properly synchronized. If a mobile device is receiving base station signals, test 250, such as it is able to send and receive CDMA cellular telephones calls, the mobile device may receive the base station synchronization signals, step 252, and use those signals to synchronize its clock circuit in a conventional manner, step 260. However, if the mobile device is not receiving base station signals (i.e. test 250=“No”), the mobile device may determine if GPS signals are being received, test 254. If GPS signals are being received by an internal GPS receiver (i.e., test 254=“Yes”), the processor 21 may extract a timing signal from the GPS time information, step 256, and use that extracted time signal to synchronize its internal clock, step 260. However, GPS signals cannot be received in all locations, such as within buildings or underground, so a third synchronization alternative can be provided. Specifically, if GPS signals are not being received (i.e., test 254=“No”), the mobile device can receive a time synchronization signal transmitted by a group leader of a tactical communication group, step 258, and use that synchronization signal to synchronize its internal clock, step 260.

By synchronizing all mobile devices to the internal clock of a single “leader” of a tactical communication group the various embodiments enable CDMA communications to be reliably continued even when no other timing signals are available. In order to ensure that communications within a tactical communication group are reliable, a particular mobile device may be elected as the leader at the time that a tactical communication group is set up (e.g., when users agree on the channel or PN offset to use for the group). From then on, the leader mobile device may periodically transmit synchronization signals even when synchronization signals are available from local cellular networks and GPS signals are receivable. In such situations, the leader mobile device will remain synced with the available cellular base station signals like all other mobile devices within range of the base station. Thus, at this point the leader's synchronization signals are redundant to the timing information provided by the base station. If cellular base station communications is lost, the leader mobile device and all other will devices may begin using GPS signals to remain synchronized. Thus, the leader's synchronization signals are redundant to the timing information provided by the GPS system. Then, if GPS signals are lost, mobile devices within the tactical communication group will remain in synchronization relying upon the synchronization signals of the leader mobile device. Whenever GPS or cellular base station signals are recovered, the leader mobile device, as well as other mobile devices within the communication group, will synchronize with those timing sources. In this manner, all mobile devices will remain in synch with the leader mobile device. Also, if a portion of the mobile devices within a communication group are not able to receive cellular or GPS timing signals, they will nevertheless remain synched with the group by synchronizing upon the synchronization signals transmitted by the leader mobile device.

The leader mobile device can issue periodic synchronization signals in a manner very similar to that of cellular base stations. FIG. 19 illustrates an example synchronization symbol data packet 300 that may be generated and transmitted by the leader mobile device. This synchronization symbol data packet 300 may include a PN offset 302 corresponding to the tactical communication group, and a group leader ID 304 to enable other mobile devices to determine that the packet is coming from the group leader. In a payload of the synchronization symbol data packet 300 may be a synchronization symbol 306. Such a synchronization symbol may be a characteristic pattern of bits or a particular waveform which is recognizable and has a pattern that enables a clock circuit in a receiving mobile device to become synchronized with the timing signal. Methods for generating synchronization symbols are well known in the CDMA art. Finally, the synchronization symbol data packet 300 may include an end symbol 308 to inform the receiving mobile devices that the packet is complete.

The various embodiments may be implemented by a computing device processor 21 executing software instructions configured to implement one or more of the described methods. Such processors may be microprocessor units, microcomputer units, programmable floating point gate arrays (FPGA), and application specific integrated circuits (ASIC) as would be appreciated by one of skill in the art. Such software instructions may be stored in memory 22 as separate applications, as part of the computer's operating system software, as a series of APIs implemented by the operating system, or as compiled software implementing an embodiment method. Further, the software instructions may be stored on any form of tangible processor-readable memory, including: a random access memory 22, hard disc memory, a read only memory (such as an EEPROM), and/or a memory module (not shown) plugged into the mobile device 20, such as an external memory chip or a USB-connectable external memory (e.g., a “flash drive”). Alternatively, some steps or methods may be performed by circuitry that is specific to a given function.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order.

Those of ordinary skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware, firmware, or software depends upon the particular application and design constraints imposed on the overall system. Those of ordinary skill in the art may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile device are intended to encompass any one or all memory modules within the mobile device without limitation to a particular configuration, type, or packaging. An exemplary storage medium is coupled to a processor in the mobile device such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

I claim:

1. A method for providing peer-to-peer direct mode only communications among two or more mobile devices equipped with wireless WiFi transceivers, comprising:
establishing an ad hoc WiFi network among the mobile devices;
converting sound into digital sound data in a first mobile device;
packaging the digital sound data into a data packet for transmission over the ad hoc WiFi network;
transmitting the data packet via the ad hoc WiFi network to a second mobile device;
receiving the data packet at the second mobile device; and
converting the digital sound data into sound in the second mobile device.

2. The method of claim 1, further comprising:
associating a communication group identifier with the ad hoc WiFi network;
including the communication group identifier in the data packet;
extracting the communication group identifier from the data packet in the second mobile device;
comparing the communication group identifier to a group identifier assigned to the second mobile device; and
ignoring the data packet if the communication group identifier does not match the group identifier assigned to the second mobile device,
wherein the step of converting the digital sound data into sound in the second mobile device is performed if the communication group identifier matches the group identifier assigned to the second mobile device.

3. The method of claim 1, further comprising receiving a CDMA communication in the first mobile device while transmitting the data packet via the ad hoc WiFi network to the second mobile device.

4. The method of claim 1, further comprising receiving a CDMA communication in the second mobile device while receiving the data packet at the second mobile device.

5. A method for providing peer-to-peer direct mode only communications among two or more CDMA mobile devices, comprising:
associating a communication group pseudorandom number (PN) offset with peer-to-peer communications among the two or more CDMA mobile devices, the communication group PN offset being different from any PN offset assigned by a cellular base station to any of the two or more CDMA mobile devices;
converting sound into digital sound data in a first mobile device;
packaging the communication group PN offset and the digital sound data into a CDMA data packet;
transmitting the CDMA data packet from the first mobile device;
receiving the CDMA data packet at a second mobile device;
extracting the communication group PN offset from the data packet in the second mobile device;
comparing the communication group PN offset to a communication group PN offset assigned to the second mobile device;
ignoring the CDMA data packet if the communication group PN offset does not match the communication group PN offset assigned to the second mobile device; and
converting the digital sound data into sound in the second mobile device if the communication group PN offset matches the communication group PN offset assigned to the second mobile device.

6. The method of claim 5, further comprising synchronizing a clock circuit within the second mobile device to a synchronization signal transmitted by the first mobile device.

7. The method of claim 5, further comprising synchronizing a clock circuit within the first mobile device to a timing signal received from a Global Positioning System receiver within the first mobile device.

8. The method of claim 5, wherein the CDMA data packet is transmitted at a frequency equal to a transmission frequency of a cellular base station.

9. The method of claim 5, wherein the CDMA data packet is transmitted at a frequency approximately equal to a standard mobile-to-base station uplink frequency.

10. The method of claim 5, wherein the CDMA data packet is transmitted at a frequency not approximately equal to a standard mobile-to-base station uplink frequency.

11. The method of claim 5, further comprising receiving in the first mobile device a CDMA transmission from a cellular base station while transmitting the CDMA data packet from the first mobile device.

12. The method of claim 5, further comprising receiving in the second mobile device a CDMA transmission from a cellular base station while receiving the CDMA data packet in the second mobile device.

13. A mobile device, comprising:
a processor;
a CDMA transceiver coupled to the processor;
a vocoder coupled to the processor;
a microphone coupled to the vocoder;
a speaker coupled to the vocoder; and
a memory coupled to the processor,
wherein the processor is configured with executable software instructions to perform steps comprising:
associating a communication group pseudorandom number (PN) offset with peer-to-peer communications with a second mobile device, the communication group PN offset being different from a PN offset assigned by a cellular base station to any mobile device;
converting sound into digital sound data;
packaging the communication group PN offset and the digital sound data into a first CDMA data packet;
transmitting the first CDMA data packet via the CDMA transceiver to the second mobile device;
receiving a second CDMA data packet via the CDMA transceiver from the second mobile device;
extracting a received PN offset from the second data packet;
comparing the received PN offset to the communication group PN offset;
ignoring the second CDMA data packet if the received PN offset does not match the communication group PN offset; and
converting the digital sound data into sound if the communication group PN offset matches the communication group PN offset assigned to the mobile device.

14. The mobile device according to claim 13, further comprising a clock circuit coupled to the processor, wherein the processor is configured with executable software instructions to perform further steps comprising synchronizing the clock circuit to a synchronization signal received via the CDMA transceiver from the second mobile device.

15. The mobile device according to claim 13, further comprising:
a clock circuit coupled to the processor; and
a Global Positioning System receiver coupled to the processor,
wherein the processor is configured with executable software instructions to perform further steps comprising synchronizing the clock circuit to a timing signal received from the Global Positioning System receiver.

16. The mobile device according to claim 13, wherein the CDMA transceiver comprises:
a transmitter circuit; and
a dual mode receiver circuit configured to receive and process signals transmitted at a frequency approximately equal to a standard mobile-to-base station uplink frequency and at a standard base station-to-mobile downlink frequency.

17. The mobile device according to claim 16, further comprising:
an antenna coupled to the transmitter circuit and the dual mode receiver circuit; and
a transmission cutout switch coupled between the antenna and the dual mode receiver circuit, the transmission cutout switch configured to disconnect the dual mode receiver circuit from the antenna when the transmitter circuit is transmitting.

18. The mobile device according to claim 13, further comprising an antenna coupled to the CDMA transceiver, wherein the CDMA transceiver comprises:
a transmitter circuit;
a first receiver circuit configured to receive and process signals transmitted at a mobile-to-base station uplink frequency;
a second receiver circuit configured to receive and process signals transmitted at a base station-to-mobile downlink frequency; and
transmission cutout switch coupled between the antenna and the first receiver circuit, the transmission cutout switch configured to disconnect the first receiver circuit from the antenna when the transmitter circuit is transmitting.

19. The mobile device according to claim 13, further comprising an antenna coupled to the CDMA transceiver, wherein the CDMA transceiver comprises:
a first transmitter circuit configured to transmit signals at a mobile-to-base station uplink frequency;
a first receiver circuit configured to receive and process signals transmitted at a base station-to-mobile downlink frequency;
a second transmitter circuit configured to transmit signals at a transmission frequency other than the base station-to-mobile downlink and mobile-to-base station downlink frequencies;
a second receiver circuit configured to receive and process signals transmitted at the transmission frequency of the second transmitter circuit; and
a transmission cutout switch coupled between the antenna and the second receiver circuit, the transmission cutout switch configured to disconnect the second receiver circuit from the antenna when the second transmitter circuit is transmitting.

20. The mobile device according to claim 13, wherein the processor is configured with executable software instructions to perform further steps comprising receiving a CDMA transmission from a cellular base station while transmitting the CDMA data packet.
